(19) United States
(12) Patent Application Publication
(10) Pub. No.: US 2002/0117982 A1
(43) Pub. Date: Aug. 29, 2002

(54) Method for controlling an electric motor

(75) Inventor: Rainer Jehn, Ingolstadt (DE)

Correspondence Address: FASSE PATENT ATTORNEYS, P.A., P.O. BOX 726, HAMPDEN, ME, 04444-0726, US

(73) Assignee: Conti Temic microelectronic GmbH, Nuernberg (DE)

(21) Appl. No.: 10/061,827

(22) Filed: Jan. 31, 2002

(30) Foreign Application Priority Data
Feb. 23, 2001 (DE) 101 08 975.9

(51) Int. Cl. H02P 1/00; H02P 1/22; H02P 1/40; H02P 3/00; H02P 3/20; H02P 5/00; H02P 7/00

(52) U.S. Cl. 318/280

(57) ABSTRACT

The invention relates to a method for controlling an electric motor in which each of its terminal contacts can optionally be connected via the changeover contacts of controllable changeover switches to one of the two poles of a power supply source and the changeover switches are switched over in order to reverse the electric motor.

It is a well known art with actuating devices for moving windows, partitions or sliding roofs from a separate power source in motor vehicles to perform reversal of the electric motor should an obstacle be encountered, for instance in the event of a trapping situation occurring. Since the reversing operation is performed by relays, and since the armature of such relays must be moved before a changeover, this changeover operation lasts at least 1.5 msec and therefore during this period of time the torque generated by the electric motor and the trapping force in the case of window winders increases even further.

In order to accomplish faster switch-off when such a trapping situation occurs, as soon as reversal commences the load circuit is switched off by means of an electronic switch before the changeover of the relays and switched on again only when the relays performing reversal have changed over.

### BACKGROUND

1. Field of the Invention

The invention relates to a method for controlling an electric motor in which each of its terminal contacts can optionally be connected via the changeover contacts of a controllable changeover switch to one of the two poles of a power supply source and the changeover switches are switched over in order to reverse the electric motor.

2. Description of the Related Technology

A method of this kind is known from DE 3135888 A1 in which a servomotor as electric actuating device can be controlled in a clockwise or counterclockwise direction by means of two relays in that semiconductor switches connected to the relay windings are fed with control signals.

Actuating devices of this kind are used in particular to move windows, partitions or sliding roofs from a separate power source in motor vehicles between an open end position and a closed end position, where in addition a limit as defined by safety regulations is imposed on the closing force when an obstacle is contacted so that when such an obstacle is encountered the movement is stopped or reversed.

In such systems, it is therefore important to switch off or reverse the servomotor as quickly as possible should such a trapping situation occur in order to thereby reduce the trapping force. The above known relay-controlled actuating device does however have the disadvantage that if reversal takes place the mechanical relay contacts must be moved during reversal, although this requires that the relay armature be in motion and consequently takes up a lot of time, at least 1.5 msec, during which the trapping force is further increased.

### SUMMARY OF THE INVENTION

The object of the present invention is to further develop the method of the type named at the outset in such a way that the electric motor is caused to switch off rapidly when a trapping situation occurs.

According to the present invention, the load circuit routed via the relay contacts is switched off by means of an electronic switch as soon as the control operation for reversing commences and it is switched on only after the changeover operation for ending reversing is initiated, i.e. when the changeover switches have been switched over. Because of the considerably faster reaction of the semiconductor switch compared with the changeover switch, it is ensured that the load circuit disconnects rapidly. A transistor, and in particular a field-effect transistor, is used with preference as electronic switch.

### BRIEF DESCRIPTION OF THE FIGURES

The method according to the invention will now be described and explained in more detail with reference to the Figures. The Figures show:

FIG. 1 A circuit arrangement for performing the method according to the invention, and

FIG. 2 Diagrams of voltage/current against time to explain the mode of function of the circuit arrangement shown in FIG. 1.

### DESCRIPTION OF THE PREFERRED EMBODIMENTS

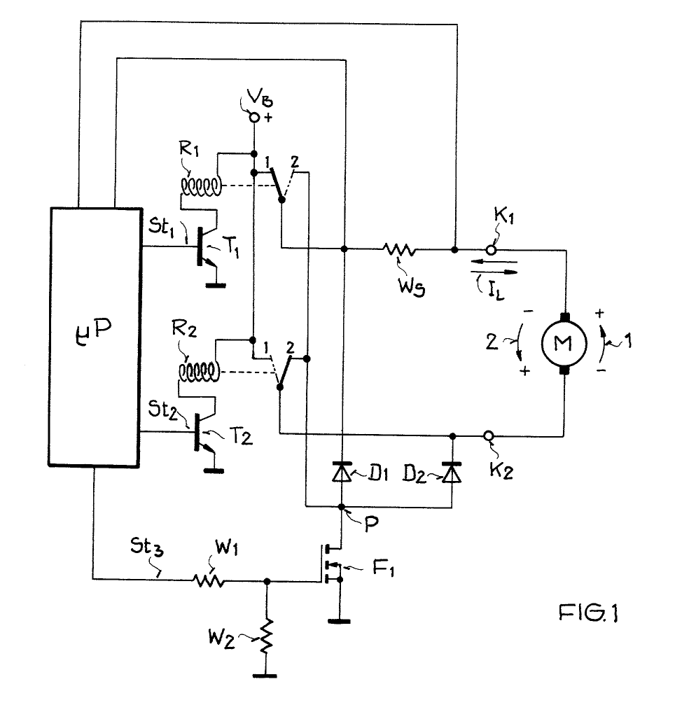

The electric motor M shown in FIG. 1, which can be used as servomotor for moving windows, partitions and sliding roofs operated by an external power source in motor vehicles, can be connected over its two terminal contacts K₁ and K₂ via relay contacts of two relays R₁ and R₂ to the poles of a power supply source V_{B}. The relay coils of the two relays R₁ and R₂ can also be connected over an electronic switch, in particular of a transistor T₁ and T₂, to the named power supply source V_{B}, the control electrodes of these two transistors T₁ and T₂ being connected to a control unit μP in order to generate corresponding control signals St₁ and St₂ generated by the control unit μP for these transistors.

In FIG. 1, transistor T₁ is made conductive so that the terminal contact K₁ of the electric motor M is connected via the relay contact in position 1 with the plus pole of the power supply source V_{B}, while the transistor T₂ is in the non-conductive state, resulting in the relay contact of the relay R₂ being in its normal position (position 2), so that the second terminal contact K₂ of the electric motor M is connected to a circuit junction P.

This circuit junction P is connected to ground over an electronic switch, in particular a field-effect transistor F₁, so that in the conducting state of this field-effect transistor F₁ the electric motor M displays a first direction of rotation (arrow 1). The load current IL thereby generated is measured by means of a shunt W_{S} connected between the first terminal contact K₁ of the electric motor M and the relay contact of the relay R₁ and fed to the control unit μP where it is evaluated. In order to put the field-effect transistor F₁ into the conductive state, a corresponding control signal St₃ is generated by this control unit μP and applied to the electrode of this field-effect transistor F₁ over a voltage divider made up of two resistors W₁ and W₂.

Finally, the circuit arrangement according to FIG. 1 also has two freewheeling circuits for the electric motor M that connect the circuit node P to the first terminal contact K₁ of the electric motor M with a first diode D₁ and a second diode D₂ which connects the circuit junction P to the second terminal contact K₂ of the electric motor M. When the electric motor M is switched off, that is when the relay contacts of the two relays R₁ and R₂ are switched to position 2, this causes the current which is induced to decay through diode D₁ or diode D₂ depending on the direction of rotation of the motor M. This short-circuiting of the two terminal contacts K₁ and K₂ results in the electric motor M being restricted in its motion.

In order to cause the electric motor M to rotate in the second direction (arrow 2), the relay R₂ is put into its operated condition so that now its relay contact connects the second terminal contact K₂ of the electric motor M to the plus pole of the power supply source V_{B}. For this purpose, the transistor T₂ is put into the conductive state by the control unit μP with a corresponding control signal St₂ while the relay R₁ remains deenergized so that its relay contacts stay in the normal condition 2.

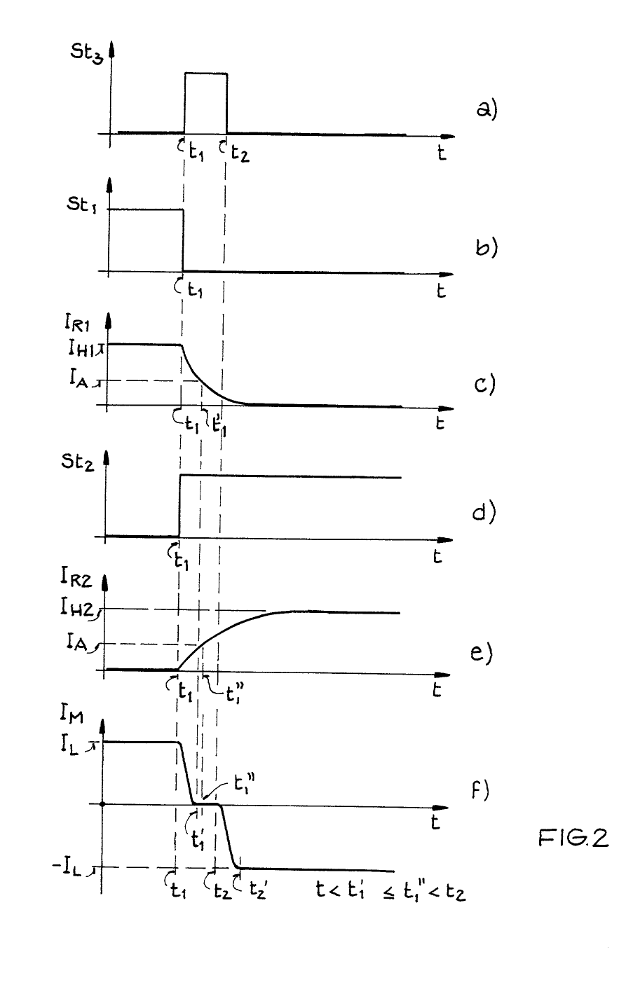

The method according to the invention will now be described with reference to the diagrams in FIG. 2.

If the electric motor M encounters an obstacle, its load current I_{L} increases which results in a growing voltage drop at the shunt W_{S}. If this voltage drop reaches a predetermined limit value, the control unit μP generates at a time t₁ a corresponding control signal St₃ in order thus to block the field-effect transistor F₁ and consequently to switch off the load circuit of the electric motor M. Because of this switch-off signal at time t₁ (see FIG. 2a), the load current I_{L} is switched off shortly after this time t₁, as shown in FIG. 2f. The reversing operation commences simultaneously at time t₁ by reversing the relays R₁ and R₂ in such a way that the electric motor M changes from the first direction of rotation (arrow 1) to the second direction of rotation (arrow 2).

For this purpose, the control unit pP generates in accordance with FIG. 2b a control signal St₁ in order to block the transistor T₁ in order to switch the relay R₁ into its normal condition (position 2). Consequently, as shown in FIG. 2c, the holding current I_{H1} of the relay R₁ falls exponentially because of the inductive reactance of the relay coil and at a later time t₁′ it falls below the holding current I_{A} of the relay and therefore the relay contact does not drop out until this time. At this time t₁′, however, the load current I_{L} has been switched off by means of the field-effect transistor F₁.

In order to reverse the direction of rotation of the electric motor M, its second terminal K₂ must be connected to the plus pole of the power supply source V_{B} by making the transistor T₂ conductive by means of a corresponding control signal St₂ in accordance with FIG. 2d, as a result of which the relay current I_{R2} of the relay R₂ rises exponentially—as shown in FIG. 2e—until the pickup current I_{A} is reached at time t₁″ when as a consequence the armature of relay R₂ switches the relay contact into the operated condition, that is in position 1, as a result of which the second terminal contact K₂ of the electric motor M is connected to the plus pole of the power supply source V_{B}. The relay current continues to rise until it has reached the value of the holding current I_{H2}.

After reversal of the two relays R₁ and R₂ has been concluded at time t₁″, a control signal is applied to the field-effect transistor F₁ at a subsequent time t₂ in accordance with FIG. 2a and makes the field-effect transistor F₁ conductive once again thus causing the load current circuit of the electric motor M to close again at time t₂′.

Since a switch-off signal St₃ is fed to the field-effect transistor F₁ at the same time as the switch-off signal St₁ is fed to the transistor T₁, the load current circuit of the electric motor M does not switch off at the changeover time t₁′ of relay R₁ but at an earlier time so that as soon as it is detected that the electric motor M has encountered an obstacle—for instance, a trapping situation—the load current circuit is switched off immediately. As soon as the second relay has also changed into the deenergized state, the load current circuit is switched on again by operating the field-effect transistor F₁. The time difference between the switch-off time t₁ and the switch-on time t₂ of this field-effect transistor F₁ is required for this purpose and must be determined on the basis of the relays R₁ and R₂ because this field-effect transistor F₁ must remain switched off all the time until on the one hand the reversal has been completed and on the other hand this time difference must not be longer than the relays R₁ and R₂ need for current reversal. The times indicated in FIG. 2 are related as follows: t₁<t₁′<t₁″<t₂.

The encountering of an obstacle is detected in the example of embodiment shown in FIG. 1 by measuring the load current I_{L}. The rotational speed of the electric motor can also be defined as the means of detecting an obstacle. In this case, it is assumed that an obstacle has been encountered when the speed drops below a certain threshold value.

What is claimed is:

1. Method for controlling an electric motor (M) in which each of its terminal contacts (K₁, K₂) can optionally be connected via the changeover contacts of controllable changeover switches (R₁, R₂) to one of the two poles of a power supply source (V_{B}) and where the changeover switches (R₁, R₂) are switched in order to reverse the electric motor (M), wherein as soon as the control operation commences for reversing the electric motor (M) one of the two poles of the power supply source (V_{B}) is disconnected from the changeover contacts of the two changeover switches (R₁, R₂) by means of an electronic switch (F₁) and where this pole is connected once again to the relay contacts by means of the electronic switch (F₁) only after changing over for the purpose of ending reversal.

2. Method in accordance with claim 1, wherein the changeover switches are in the form of relays (R₁, R₂) and the electronic switches (F₁) are in the form of semiconductor switches and in particular transistors.
